(19) United States
(12) Patent Application Publication
(10) Pub. No.: US 2023/0165323 A1
(43) Pub. Date: Jun. 1, 2023

(54) MASK FRAME AND METHOD OF USING THE MASK FRAME

(71) Applicant: YUSOH WARIKATA, Kanagawa (JP)

(72) Inventor: YUSOH WARIKATA, Kanagawa (JP)

(21) Appl. No.: 17/595,929

(22) PCT Filed: Jun. 15, 2021
(86) PCT No.: PCT/JP2021/022693

§ 371 Date: Nov. 29, 2021

(30) Foreign Application Priority Data
Aug. 14, 2020 (JP) 2020-137003

(51) Int. Cl. A41D 13/11; A62B 18/08; A62B 23/02

(52) U.S. Cl. CPC A41D 13/1107; A62B 18/08; A62B 23/025

(57) ABSTRACT

An object is to provide a mask frame capable of allowing a mouth to be less likely to be constrained by a frame at the time of talking while preventing a mask from coming into contact with a part around the mouth and a nose and capable of fitting to a face regardless of the face shape of each person and a method of using the mask frame. A mask frame (1) includes: two vertical materials (2) that are disposed such that a longitudinal direction of the vertical materials is aligned along an up-down direction when the mask frame is worn on a face, and come into contact with left and right cheeks, respectively; a plurality of horizontal materials (3) that are provided between the vertical materials (2) such that a longitudinal direction of the horizontal materials is aligned along a horizontal direction and are disposed at positions away from the face when the mask frame is worn on the face; and a reinforcing material (4) that is disposed such that a longitudinal direction of the reinforcing material is aligned along the up-down direction when the mask frame is worn on the face and is connected to each of the plurality of horizontal materials (3), in which the vertical materials (2), the horizontal materials (3), and the reinforcing material (4) are placeable further inward than an outer peripheral edge of a filter of a mask, and all the plurality of horizontal materials (3) are away from the face such that no part of each horizontal material (3) comes into contact with the face when the mask frame is worn on the face.

### TECHNICAL FIELD

The present invention relates to a mask frame placed in a sanitary mask and a method of using the mask frame.

### BACKGROUND ART

Sanitary masks (hereinafter, referred to as “masks”) include filters made of porous materials or the like, such as clothes, non-woven clothes, or sponges, with thin thicknesses, and the masks themselves are made of materials that are unlikely to hold their shapes. When the masks are worn on faces, mask filters come into contact with the faces, and the filters may come into close contact with the faces, mouths, parts around the mouths, lips (hereinafter, the mouths, the parts around the mouths, and the lips will be collectively referred to as “mouths”), noses, and the like depending on how to breathe. Typical masks keep their shapes along the noses by wires being incorporated along upper sides of the filters. Also, in a case in which the filters have pleats shapes, the filters are more likely to be held in shapes along the face shapes by folded parts being widened. As other typical masks, there are masks provided with folding lines in the up-down direction at centers of the masks in the width direction and having two-folded shapes and masks that can be freely folded, and many of these have three-dimensional shapes when the masks are widened.

### CITATION LIST

### Patent Literature

### [PTL 1]

the Publication of Japanese Examined Utility Model Registration No. 3105617

### [PTL 2]

the Publication of Japanese Examined Utility Model Registration No. 3117120

### [PTL 3]

the Publication of Japanese Examined Utility Model Registration No. 3117121

### [PTL 4]

Korean Patent Registration No. 10-1855114

### [PTL 5]

the Publication of Japanese Patent No. 5373994

### SUMMARY OF INVENTION

### Technical Problem

If mask filters come into contact with mouths, cheeks, or noses, wearers may feel difficulties in breathing or talking, feel uncomfortable, or have troubles in makeup collapse due to adhesion of lip colors or cosmetics to the masks. Also, wearers who need to wear the masks during exercises or sleeping may feel difficulties in breathing and feel uncomfortable since the filters may stick to or come into contact with mouths, and wearing the masks for long periods of time is thus accompanied with difficulties. Moreover, wearing the masks for long periods of time may cause positional deviations or losing of shapes of the masks. On the other hand, peripheries of the masks need to be in contact with the faces such that particles, viruses, and the like are prevented from entering or released through noses and mouths.

For example, PTLs 1 to 5 disclose that masks are worn with shape keeping tools or frames (hereinafter, collectively referred to as “mask frames”) provided in combination with masks forming spaces between mouths and filters and coming into contact along parts around the mouths and noses. However, these mask frames are held in constant shapes using synthetic resin materials with relatively high strength and are adapted on the assumption that all members at outer peripheries of the mask frames come into contact with faces. However, individual persons have different face shapes, and thus the mask frames having constant shapes may not fit along the parts around the mouths and the noses. Also, the entire outer peripheries of the mask frames come into contact with the parts around the mouths and the noses, the mouths are constrained, which leads to difficulties in talking. Moreover, if the wearers still try to talk in a state where the wearers wear the mask frames, the masks move down with motions of mouths and chins, and it is not possible to cover the noses and the mouths with the masks in the end. Therefore, the positions of the lowered masks with viruses adhering thereto are to be corrected with fingers. It is known that if mucosal parts such as noses, mouths, and eyes are touched with the fingers, probabilities of infection will increase. In addition, the mask frames that are not secured to the masks have problems in that the positions of the mask frames may easily deviate due to speeches, exercising, and the like, the masks need to be carefully removed such that the mask frames do not fall from the masks, and the masks may be excessively widened in the vertical direction.

In a case in which the aforementioned mask frames are put into masks, a main purpose is to expand the masks to prevent filters of the masks from coming into contact with skins. However, many of mask frames in the related art may be unnecessarily expanded around cheeks, the expanded parts may interrupt views below eyes, and the presence of the masks may provide an uncomfortable feeling.

The present invention was made in view of such circumstances, and an object thereof is to provide a mask frame capable of allowing a mouth to be less likely to be constrained by the frame at the time of talking while preventing the mask from coming into contact with a part around the mouth and a nose and capable of fitting to a face regardless of the face shape of each person.

### Solution to Problem

A mask frame according to the present invention includes: two vertical materials that are plate-shaped members or line-shaped members, are disposed such that a longitudinal direction of the vertical materials is aligned along an up-down direction when the mask frame is worn on a face, and come into contact with left and right cheeks, respectively; a plurality of horizontal materials that are plate-shaped members or line-shaped members provided between the vertical materials such that a longitudinal direction of the horizontal materials is aligned along a horizontal direction, have end portions connected to the vertical materials, and are disposed at positions away from the face when the mask frame is worn on the face; and a reinforcing material that is a plate-shaped member or a line-shaped member, is disposed such that a longitudinal direction of the reinforcing material is aligned along the up-down direction when the mask frame is worn on the face, and is connected to each of the plurality of horizontal materials, in which the vertical materials, the horizontal materials, and the reinforcing material are placeable further inward than an outer peripheral edge of a filter of a mask, and all the plurality of horizontal materials are away from the face such that no part of each horizontal material comes into contact with the face when the mask frame is worn on the face.

According to the configuration, the two vertical materials which are plate-shaped members or line-shaped members are disposed such that the longitudinal direction of the vertical materials is aligned along the up-down direction, and the two vertical materials come into contact with the left and right cheeks, respectively, when the mask frame is worn on the face. The plurality of horizontal materials that are plate-shaped members or the line-shaped members are provided between the vertical materials such that the longitudinal direction is aligned along the horizontal direction and have the end portions connected to the vertical materials. The horizontal materials are disposed at the positions away from the face when the mask frame is worn on the face.

The reinforcing material is disposed such that the longitudinal direction of the reinforcing material is aligned along the up-down direction and is connected to each of the plurality of horizontal materials. Since each of the plurality of horizontal materials is connected to the reinforcing material, the positions between the horizontal materials are held at predetermined intervals. Since the intervals between members are narrowed due to the reinforcing material, the filter is less likely to be attracted to the face side due to breathing, and it is possible to prevent adhesion to the face.

Although dimensions between cheekbones are not that different among human faces, individual differences in up-down dimensions from noses to chins are large. From this viewpoint, the mask frame has a structure in which only the two vertical materials come into contact with the cheeks while the plurality of horizontal materials and the reinforcing material do not come into contact with the face. With this structure, it is possible to cause the mask frame to fit the face regardless of the face shape of each person. Also, dimensions between cheekbones do not change even when mouths are moved. On the other hand, in a case in which the mask frame is not placed, a lower side of the mask moves up and down with motions of a chin when the mouth is moved for talking and the like. In a case in which the mask frame is used, the chin is not brought into contact with the lower side of the mask, no positional deviation of the upper side of the mask occurs, and it is possible to stabilize the position of the mask. Moreover, since the vertical materials come into contact with the face and the filter, it is possible to prevent blown-out breath from leaking in a lateral direction along the cheeks. Note that the vertical materials may be short and it is also possible to use dot-shaped members instead.

In the mask frame, the reinforcing material may include a first reinforcing material that is connected to each of the plurality of horizontal materials at centers of the horizontal materials, and a plurality of second reinforcing materials that are connected to each of the plurality of horizontal materials between the vertical materials and the first reinforcing material.

With this configuration, the first reinforcing material is connected to each of the plurality of horizontal materials at the centers of the horizontal materials, and the second reinforcing materials are connected to each of the plurality of horizontal materials between the vertical materials and the first reinforcing material. Since the plurality of horizontal materials are connected to each of the first reinforcing material and the second reinforcing materials, the positions among the horizontal materials are held at predetermined intervals. Also, since the intervals between members are narrowed due to the first reinforcing material and the second reinforcing materials, the filter is less likely to be attracted to the face side due to breathing, and it is possible to prevent adhesion to the face.

In the mask frame, the first reinforcing material may be placed such that an upper end portion of the first reinforcing material projects further upward than the uppermost horizontal material and/or such that a lower end portion of the first reinforcing material projects further downward than the lowermost horizontal material.

With this configuration, the projecting portions have appropriate elasticity and thus have a property that the projecting portions bow along the shape of the mask. Since the first reinforcing material placed to project further upward than the horizontal material placed on the uppermost portion is disposed with a clearance kept along a nose, a space is held between the filter of the mask and the face at the nose part. Also, since the part projecting upward acts against the mask, the upper end portion of the mask is prevented from sliding down. The first reinforcing material disposed to project further downward than the lowermost horizontal material is disposed with a clearance kept along the cheeks, and a space is held between the filter of the mask and the face at the chin part.

In the mask frame, the second reinforcing materials may be placed such that lower end portions of the second reinforcing materials project further downward than the lowermost horizontal material.

With this configuration, the second reinforcing materials placed to project further downward than the lowermost horizontal material is disposed with a clearance kept along the chin, and a space is held between the filter of the mask and the face at the chin part.

Since it is possible to keep an air passing area wide at the time of breathing due to the extra space secured by the upper and lower projecting portions of the first reinforcing material and the second reinforcing materials, this enables smooth breathing, and there is also an effect that fogging-up of glasses is curbed.

In the mask frame, the horizontal material placed at the uppermost portion among the plurality of horizontal materials may not been bent in a front outer direction between a center portion and end portions when the mask frame is worn on the face and may be configured such that the mask is placeable outside a view of a wearer.

With this configuration, the horizontal material placed at the uppermost stage from among the plurality of horizontal materials is not bent in the front outer direction between the center portion and the end portions and has a linear shape, for example, and it is thus possible to place the mask outside the view unlike a case in which the mask is bent and expanded in the front outer direction and is likely to enter a lower portion of the vision.

The mask frame may further include: projecting portions that are provided at both end portions in the horizontal direction such that each projecting portion projects in an outer direction and have a structure securable to the filter.

With this configuration, the projecting portions are inserted into through-holes opened in the filter in advance, for example, and the mask frame is reliably secured to the mask.

In the mask frame, each of all the plurality of horizontal materials may have a foldable joint member.

With this configuration, the mask frame can be folded through deformation of the horizontal materials at the joint members, and it is possible to wear the mask frame on the face by widening the mask frame and to accommodate the mask frame in a small pocket by closing the mask frame.

A method of using the mask frame includes the steps of: disposing the mask frame further inward than an outer peripheral edge of a filter of a mask on a face-side surface of the mask when the mask frame is worn on a face; and integrating the mask frame with the filter through adhesion with tapes on both sides of the mask frame in a width direction, the tapes being placed with a longitudinal direction of the tapes aligned along an up-down direction.

With this configuration, the mask frame and the filter are easily integrated using the tapes, the filter is integrated at the end portions of the filter that hardly move during use, and the mask frame is less likely to be detached. It is possible to prevent deviation between the mask and the mask frame occurring due to vibration caused by speech, exercising, and the like through the integration. Also, the tapes are not only for securing the frame but play a role as a buffer material to prevent the frame from coming direct contact with the face and damaging skin. The tapes may be attached to the entire vertical materials or may be attached only to a part such as the center portions of the vertical materials in the length direction or the like.

### Advantageous Effects of Invention

According to the present invention, it is possible to allow a mouth to be less likely to be constrained by the frame at the time of talking and to cause the mask frame to fit to the face regardless of the face shape of each person by the frame coming into contact only with the cheeks while preventing the mask from coming into contact with the part around the mouth and the nose by causing the mask to be away from the face.

### BRIEF DESCRIPTION OF DRAWINGS

FIG. 1 is a front view illustrating a mask frame.

FIG. 2 is a top view illustrating the mask frame.

FIG. 3 is a right side view illustrating the mask frame.

FIG. 4 is a back view illustrating a state in which the mask frame is placed in a mask and is a view when seen from a face-side surface of the mask.

FIG. 5 is a diagram illustrating a state in which the mask frame is worn on a face together with the mask.

FIG. 6 is a back view illustrating a state in which the mask frame is placed in a mask that has already had a three-dimensional shape and is a view when seen from the face-side surface of the mask.

FIG. 7 is a cross-sectional view illustrating a projecting portion of the mask frame and illustrates a state in which the mask frame is placed in the mask.

FIG. 8 is an overview diagram illustrating a method of folding the mask frame.

FIG. 9 is an enlarged view illustrating a folded portion of the mask frame, where FIG. 9(a) is an exploded plan view, FIG. 9(b) is a plan view illustrating a closed state, and FIG. 9(c) is a plan view illustrating an open state.

FIG. 10 is an exploded side view illustrating a folded portion of the mask frame.

FIG. 11 is an overview diagram illustrating a modification of the folded portion of the mask frame.

### DESCRIPTION OF EMBODIMENTS

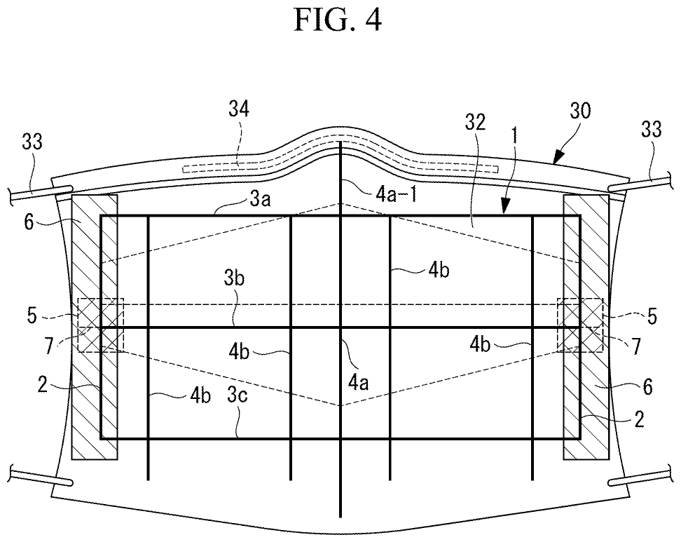

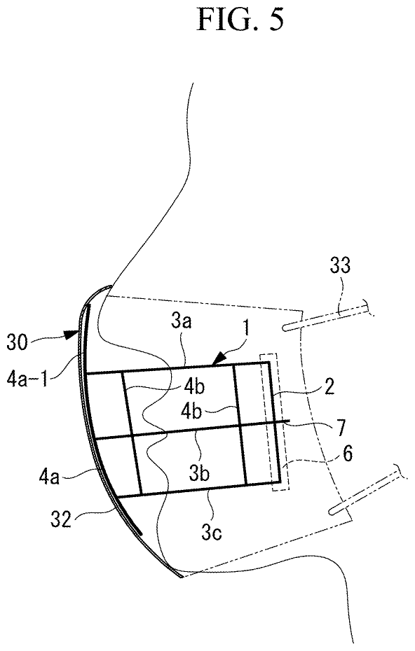

Hereinafter, a mask frame 1 will be described with reference to the drawings. The mask frame 1 has elasticity to be manually deformable has a shape that is three-dimensionally held. The mask frame 1 is used by being placed in a mask 30 that has a filter 32 made of a porous material such as a cloth, a non-woven cloth, a sponge, or the like. The mask frame 1 is disposed further inward than an outer peripheral edge of the filter 32 of the mask 30 on a face-side surface of the mask 30 when the mask frame 1 is worn on the face as illustrated in FIGS. 4 and 5. The mask frame 1 prevents the mask 30 from coming into contact with a part around the mouth and the nose by causing the mask 30 to be away from the face. Also, the mask frame 1 is away from the face such that only vertical materials 2 of the frame come into contact only with the cheeks and no part of each of all horizontal materials 3 contacts with the face when the mask frame 1 is worn on the face. This prevents the mouth from being constrained by the frame during talking. Also, it is possible to cause the mask frame 1 to fit the face regardless of the face shape of each person. Moreover, the mask frame 1 is not brought into contact with the mouth and the chin even if the mouth and the chin move at the time of talking.

The mask frame 1 is made of a synthetic resin such as a soft vinyl chloride or a silicone resin or bamboo, for example. The material of the mask frame 1 is not limited to the aforementioned examples as long as the material is highly safe and does not damage human skin and can be held in a predetermined shape while exhibiting appropriate elasticity.

If each member of the mask frame 1 is a plate-shaped member or a line-shaped member made of soft vinyl chloride, it is possible to easily perform fine adjustment of the shape, to bend each member with hands, and cause each member to be maintained in the deformed shape. The plate thickness of the plate-shaped member of each member is, for example, equal to or greater than 0.5 mm and equal to or less than 2.0 mm. Also, the width of the plate-shaped member of each member is equal to or greater than 1.0 mm and equal to or less than 5.0 mm. Note that the dimensions of the present invention are not limited to the examples.

The mask 30 to which the mask frame 1 can be applied is not limited. The mask frame 1 can be applied to the mask 30 in which the filter 32 has a rectangular shape before the mask frame 1 is worn on the face as illustrated in FIG. 4, for example, and the filter 32 is folded into a pleats shape. The mask 30 includes the filter 32, ear hook portions 33, a wire 34, and the like. The wire 34 is incorporated in the mask 30 along the upper portion of the filter 32.

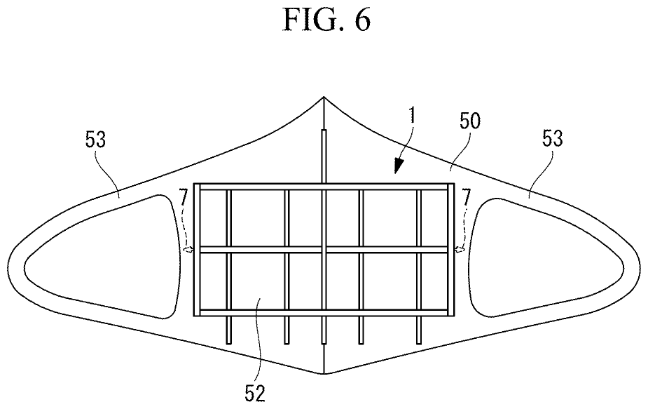

In another case, as illustrated in FIG. 6, the mask frame 1 can also be applied to a mask 50 that is provided with a folded part in the up-down direction at the center of the mask 50 in the width direction, has a shape foldable into two parts, and holds a three-dimensional shape when the mask 50 is widened. The mask 50 includes a filter 52, ear hook portions 53, and the like.

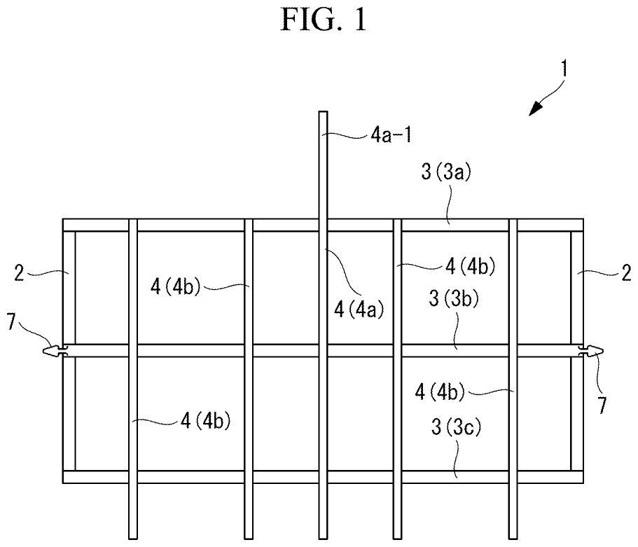

The mask frame 1 has a square shape, for example, as a shape in a front view as illustrated in FIG. 1, and only the vertical materials 2 constituting short sides on both sides in the width direction come into contact with the cheeks of the face while no part of the other members such as the horizontal materials 3 comes into contact with the face as illustrated in FIG. 5. Therefore, the part that comes into contact with the face is limited unlike the frame in the related art that is worn such that the frame comes into contact along the part around the mouth and the nose. As a result, the mask frame 1 is more likely to fit to the face regardless of the face shape of each person. Also, since no part of the horizontal materials 3 constituting long sides that are parallel to the width direction, that is, the upper side and the lower side comes into contact with the face, mouth motions are less likely to be interrupted by the frame when the part around the mouth moves up and down at the time of talking and the like.

Also, although the case in which the mask frame 1 has a square shape as the shape in a front view has been described in the aforementioned example, the present invention is not limited to this example. For example, the mask frame 1 may have an octagonal shape as a shape in a front view. In this case, the length of the vertical materials 2 in the up-down direction is shorter, and the length of the horizontal materials 3 in the horizontal direction is shorter, as compared with the example in FIGS. 1 to 3. Also, four oblique materials connecting end portions of the vertical materials 2 and end portions of the horizontal materials 3 are further placed. Unlike the example in which the shape in a front view is a square shape, sticking-out of four corners of the mask frame 1 is alleviated, the filter 32 is thus more likely to fit to roundness of cheeks and can curb air leakage from the surroundings of the cheeks, and pressing of the mask frame 1 on the face is also reduced.

As illustrated in FIGS. 1 to 3, the mask frame 1 includes two vertical materials 2, three horizontal materials 3, and five reinforcing materials 4, and these members are connected to each other and thereby constitute the mask frame 1. Each member is preferably an adhesive, and for example, a material with viscosity after curing. The connecting parts can permit deformation among members, and it is possible to prevent the members from breaking or cracking by the members exhibiting viscosity even after curing.

Note that the mask frame 1 is not limited to the plurality of members combined using an adhesive or the like and may be the members integrally formed using a molding die or the like. In this case, the members may intersect each other such that intersecting parts between the vertical materials 2 and the horizontal materials 3 or intersecting parts between the horizontal materials 3 and the reinforcing materials 4 are thick, that is, there are step differences, or the members may intersect each other with no step differences with the vertical materials 2 and the horizontal materials 3 or the horizontal materials 3 and the reinforcing materials 4 intersecting each other in the same plane, as illustrated in FIGS. 1 to 3.

As illustrated in FIG. 4, the mask frame 1 is secured to the mask 30 with tapes 5 or 6, for example. The tapes 5 are a method of securing a part of the vertical materials 2, and the tapes 6 are a method of securing the entire vertical materials 2. It is desirable that the tapes 5 and 6 are materials having stretchability and having surfaces covered with a non-woven cloth or the like that is not sticky and is less likely to damage the skin since the tapes 5 and 6 come into contact with the skin.

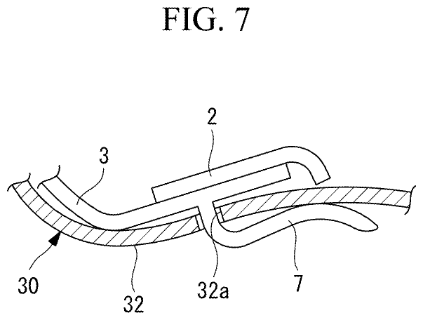

Also, the mask frame 1 may be secured to the filter 32 with projecting portions 7 provided in a surface of the mask frame 1 on the side of the filter 32, for example, as illustrated in FIGS. 4 and 7. Note that although the case in which the mask frame 1 is secured to the filter 32 using all of the tapes 5, the tapes 6, and the projecting portions 7 has been described in the example illustrated in FIG. 4, only any one or two of the tapes 5, the tapes 6, and the projecting portions 7 may be employed to secure the mask frame 1 to the filter 32. Note that in a case in which the projecting portions 7 are not used, the projecting portions 7 may be omitted.

As illustrated in FIGS. 1 to 3, the projecting portions 7 are provided at both end portions of the mask frame 1 in the horizontal direction such that each projecting portion 7 projects in the outer direction. As illustrated in FIG. 7, the projecting portions 7 are inserted into through-holes 32a opened in the filter 32 in advance. The projecting portions 7 have narrowed return parts in order to prevent pulling-out after the insertion into the filter 32 and have a shape folded in an outer direction that is opposite to the center direction of the mask 30.

The mask frame 1 is less likely to cause positional deviation due to talking, exercising, and the like by the mask frame 1 being reliably secured to the mask 30. Moreover, since the mask frame 1 is still secured to the filter 32 even after the mask 30 is removed, there is no concern that the mask frame 1 drops separately from the mask 30.

The vertical materials 2 are plate-shaped members or line-shaped members and are disposed such that the longitudinal direction is aligned along the up-down direction when the mask frame 1 is worn on the face, and the two vertical materials 2 come into contact with the left and right cheeks, respectively.

The horizontal materials 3 are plate-shaped members or line-shaped members, and three horizontal materials 3 are provided between the two vertical materials 2 such that the longitudinal direction is aligned along the horizontal direction and have end portions connected to the vertical materials 2. The horizontal materials 3 are disposed at positions away from the face when the mask frame 1 is worn on the face. Note that the horizontal material 3b may be omitted.

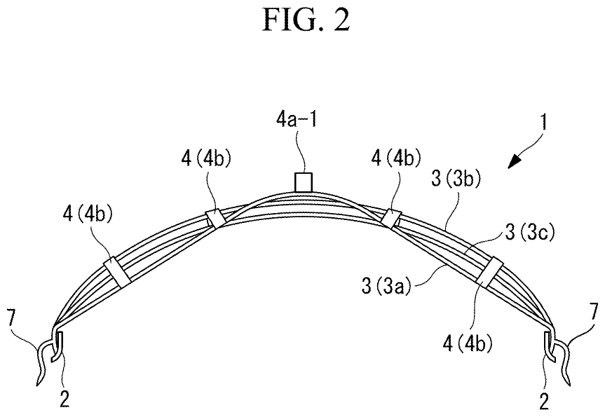

The shapes of the horizontal materials 3 are preferably different from each other. As illustrated in FIG. 2, it is desirable that the horizontal material 3a placed on the uppermost stage among the horizontal materials 3 have a linear shape without being bent in the front outer direction between the center position and the end portions. Although if the horizontal material 3a were bent and expanded in the front outer direction, then the mask 30 would be likely to enter the lower portion of the view, it is possible to place the mask 30 outside the view by the linear shape.

As illustrated in FIGS. 2, 3, and 5, the horizontal material 3b placed at the middle stage and the horizontal material 3c placed at the lowermost stage among the horizontal materials 3 are slightly bent from one end portion toward the other end portion. The horizontal materials 3b and 3c and the reinforcing materials 4 are formed into bent shapes such that the mask frame 1 and the filter 32 are not brought into contact with the mouth and the chin even if the mouth and the chin move at the time of talking.

As illustrated in FIG. 1, the reinforcing materials 4 are plate-shaped members or line-shaped members and are disposed such that the longitudinal direction of the reinforcing materials 4 is aligned along the up-down direction, and the reinforcing materials 4 are connected to each of the three horizontal materials 3. The number of reinforcing materials 4 placed is, for example, five. The positions among the horizontal materials 3 are held at predetermined intervals by the three horizontal materials 3 being connected to each of the reinforcing materials 4. Since the intervals between the members are narrowed due to the reinforcing materials 4, the filter 32 of the mask 30 is less likely to be attracted to the face side due to breathing, and it is possible to prevent adhesion to the face.

As illustrated in FIG. 1, a first reinforcing material 4a among the reinforcing materials 4 is connected to each of the three horizontal materials 3 at the centers of the horizontal materials 3. Second reinforcing materials 4b among the reinforcing materials 4 are connected to each of the three horizontal materials 3 between the vertical materials 2 and the first reinforcing material 4a. The number of second reinforcing materials 4b placed on each of left and right sides between the vertical materials 2 and the first reinforcing material 4a is two, for example. Although the two second reinforcing materials 4b placed on each of the left and right sides may be placed at equal intervals between the vertical materials 2 and the first reinforcing material 4a, one of them may be placed on the side of each vertical material 2 while the other one may be placed on the side of the first reinforcing material 4a.

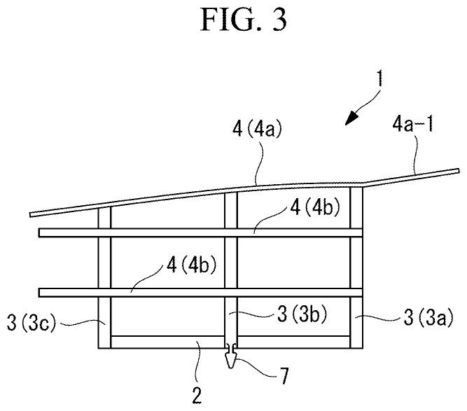

As illustrated in FIGS. 1 and 3, the first reinforcing material 4a may be placed to project further upward than the horizontal material 3a placed at the uppermost portion. Also, it is desirable that an upper end portion 4a-1 of the first reinforcing material 4a placed to project further upward than the horizontal material 3a be slightly warped on the side of the mask 30, which is an opposite side of the face, in an initial state as illustrated in FIG. 3. The upper end portion 4a-1 has appropriate elasticity, and when the first reinforcing material 4a is attached to the mask 30, the upper end portion 4a-1 bows along the shape of the mask 30, and a clearance between the filter 32 of the mask 30 and the face is held at the front part of the nose, as illustrated in FIG. 5. The upper end portion 4a-1 may be brought into contact with the nose at the distal end part.

Also, as illustrated in FIG. 5, the upper end portion 4a-1 bows along the shape of the mask 30 with appropriate elasticity and constantly presses the filter 32 forward, and it is thus possible to prevent from friction occurring between the upper end portion 4a-1 and the filter 32 and to prevent the mask 30 from sliding down. The projecting length of the first reinforcing material 4a is appropriately adjusted by the wearer in accordance with the shape, the position, and the like of the nose, such that the wearer does not feel uncomfortable when the mask frame 1 is worn. The upper end portion 4a-1 has a strength to such an extent that the upper end portion 4a-1 can be easily cut using scissors, a nail clipper, or the like.

The reinforcing materials 4 may be placed to project further downward than the lowermost horizontal material 3c. The reinforcing materials 4 placed to project further downward than the horizontal material 3c have appropriate elasticity and bow along the shape of the mask 30. In this manner, the projecting portions press the mask 30 forward, a maximum space that is allowable in a relationship of the dimension of the mask 30 and the face shape is secured, and it is also possible to prevent friction from occurring between the filter 32 and the reinforcing materials 4 and to prevent the mask 30 from deviating. Also, the clearance between the filter 32 of the mask 30 and the face is held at the parts of the mouth and the chin due to the space. The reinforcing materials 4 projecting downward are located at positions away from the face such that the projecting portions are not brought into contact with the face. The projecting length of the reinforcing materials 4 is appropriately adjusted by the wearer in accordance with the chin shape such that the reinforcing materials 4 do not come into contact with the face. The reinforcing materials 4 have such a strength that the reinforcing materials 4 can be easily cut using scissors, a nail clipper, or the like.

Note that although the case in which the first reinforcing material 4a projects further upward than the horizontal material 3a and the first reinforcing material 4a and the second reinforcing materials 4b project further downward than the horizontal material 3c has been illustrated and described in the aforementioned example, the present invention is not limited to this example. End portions of the first reinforcing material 4a and the second reinforcing materials 4b may be connected to the horizontal materials 3a and 3c and may not project from the horizontal materials 3a and 3c.

It is desirable that the second reinforcing materials 4b do not project further upward than the horizontal material 3a placed at the upper most portion. If the second reinforcing materials 4b project further upward than the horizontal material 3a, the mask 30 is excessively expanded on the front outer side, and the mask 30 is likely to enter the lower portion of the vision.

Note that the numbers of the horizontal materials 3 and the reinforcing materials 4 are not limited to those in the aforementioned example and may be other numbers in the present invention. Also, the size of the mask frame 1 can be set in various manners in accordance with the wearer and the size of the mask 30.

Next, a method of using the mask frame 1 will be described.

### Procedure 1:

The mask 30 is placed in a flat location with the face side facing up. Then, the up-down and front-back directions are aligned between the mask 30 and the mask frame 1, and the mask frame 1 is placed on the mask 30 such that the center of the mask 30 overlaps the center of the mask frame 1.

### Procedure 2:

The short tapes 5 for temporary attachment are attached to the centers of the vertical materials 2 in the length direction to integrate the mask 30 with the mask frame 1. Then, the wearer wears the mask 30 and the mask frame 1 on his/her face and see his/her face with the mask 30 and the mask frame 1 in a mirror. The wearer spread the mask 30 on the upper and lower sides and makes the mask 30 fit the shape of the mask frame 1 while seeing the mirror. Note that in the case in which the projecting portions 7 are used, the positions of the projecting portions 7 on the mask 30 are marked when the mask frame 1 is placed on the mask 30, and the through-holes 32a are formed in the filter 32 at the parts using pins or the like. Then, the projecting portions 7 are inserted into the through-holes 32a to integrate the mask 30 with the mask frame 1. When the through-holes 32a are opened, sharp pin tips are used to open gaps of fiber of the mask 30 and expand the openings with the fiber itself prevented from being damaged. In this manner, the through-holes 32a are not expanded even if a mechanical force is applied to the through-holes 32a after the mask frame 1 is integrated with the mask 30, and thus air leakage does not occur.

### Procedure 3:

In a case in which the lower projecting parts of the reinforcing materials 4 stick out of the outline of the chin or the wearer feels that the lower projecting parts are too long when the wearer sees the mirror, parts at an appropriate length are marked with a pen. Also, in a case in which the upper end portion 4a-1 excessively sticks out above the nose, or the wearer feels that the upper end portion 4a-1 is too long, a part at an appropriate length is marked with a pen. Thereafter, the mask 30 and the mask frame 1 are detached from the face, the mask 30 is turned over, and the projecting parts of the reinforcing materials 4 are cut at the positions of the marks.

### Procedure 4:

The lengths of the upper and lower projecting parts of the mask frame 1 are adjusted to the length in accordance with preference of the wearer through the procedures 1 to 3, and a state in which the mask 30 fits the shape of the mask frame 1 is achieved. The pleats of the mask 30 are in a state in which they are expanded at the center and are narrowed at left and right ends. The entire vertical materials 2 are covered with the tapes 6 that are longer than the vertical materials 2 in a state in which the left and right ends of the mask 30 in the narrowed state are kept as they are, the tapes 6 are attached to the mask 30 to further fixedly integrate them, and the procedures are completed.

If the tapes 5 are peeled off when the tapes 6 are attached, the narrowed state may collapse, or the position of the mask frame 1 may deviate, and it is thus possible to further safely and accurately achieve the integration by attaching the tapes 6 on the tapes 5.

Note that if the projecting parts of the reinforcing materials 4 are not necessary, the entire projecting parts may be cut to be aligned with the positions of the horizontal material 3a and the horizontal material 3c. Also, although the attachment of the tapes 6 has an effect that excessive expansion of the mask 30 is curbed and contact of the corners of the square of the mask frame 1 with the face is softened, the tapes 6 may not be attached if the wearer does not care about it.

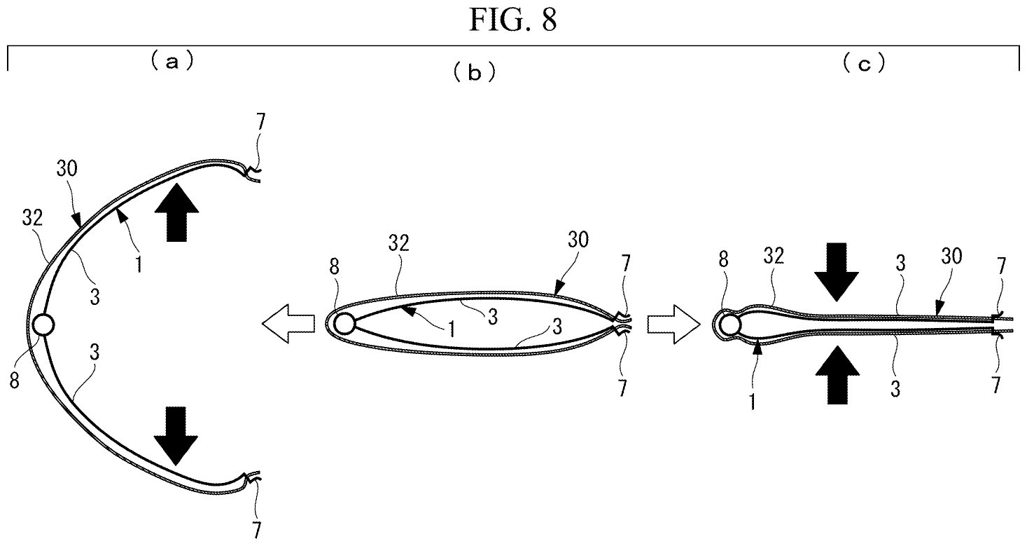

Next, a folded structure of the mask frame 1 will be described with reference to FIGS. 8 to 11. Each of all the plurality of horizontal materials 3 may be provided with a foldable joint member 8. Some joint members 8 are realized with a structure like a hinge, and other joint members 8 are realized using elasticity of the material, such as joint members 8 realized mainly by elasticity of the material like springs or bent material, for example. The joint members 8 are provided at the center parts of the horizontal materials 3 in the length direction as illustrated in FIG. 8(a), for example. In this manner, the mask frame 1 can be folded by the horizontal material 3 being deformed at the joint members 8.

First, the mask frame 1 is produced such that a state in which the mask frame 1 is folded into two parts and is slightly expanded is an initial state as illustrated in FIG. 8(b). If a force in a sandwiching direction is applied to the mask frame 1 in the state in FIG. 8(b), then the mask frame 1 becomes thin as in FIG. 8(c) due to elasticity of the horizontal materials 3, and it is possible to easily accommodate the mask frame 1 in a small pocket. Although if a force is applied in a direction in which the mask frame 1 is opened in the state in FIG. 8(b), then the horizontal materials 3 are expanded as in FIG. 8(a), the horizontal materials 3 are not expanded any more by employing the joint members 8 with a structure or strength with which the horizontal materials 3 are not expanded any more due to a force of rubber cords of the ear hook portions 33 of the mask 30, when the mask 30 is worn on a face, the expansion of the mask frame 1 is maintained. Also, since the joint members 8 realized using elasticity of the material automatically shrink into the initial state in FIG. 8(b) due to the elasticity of the joint members 8 with the mask 30 and the mask frame 1 integrated when the attached mask 30 is removed from the face, it is possible to omit efforts to fold the mask 30 and the mask frame 1.

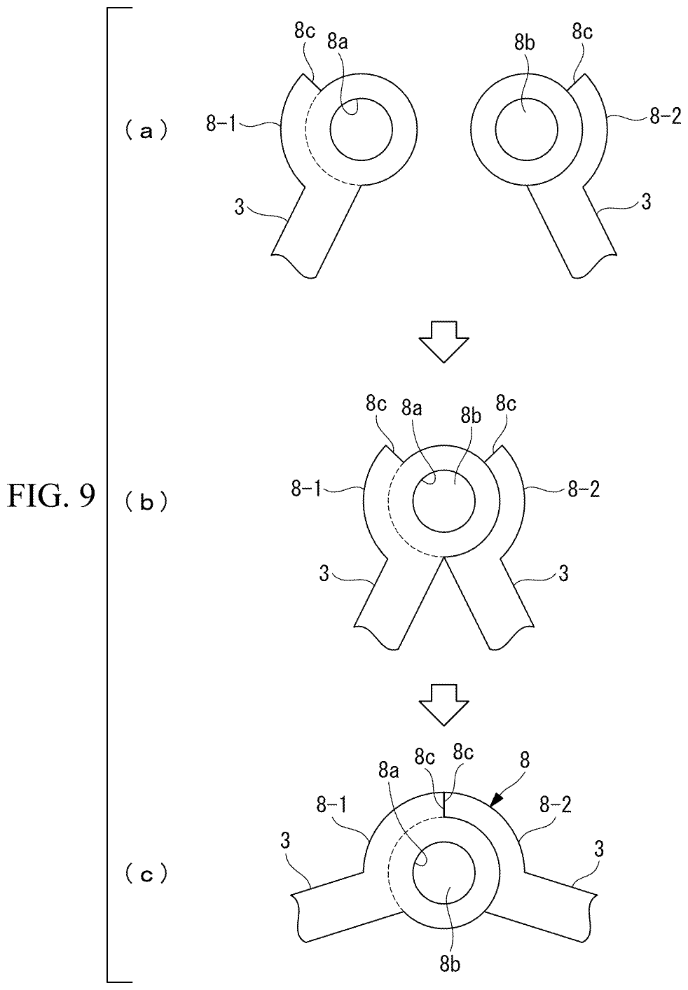

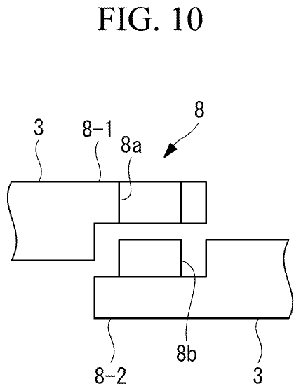

If the joint members 8 are realized by a hinge structure, the structure as in FIG. 9 is employed. As illustrated in FIGS. 9(a) and 10, a through-hole 8a is formed at a connecting portion 8-1 (female member), a projecting portion 8b is formed at a connecting portion 8-2 (male member), and the projecting portion 8b is fitted into the through-hole 8a thereby to realize each joint member 8. In the hinge structure, excessive spreading of the horizontal materials 3 is prevented by abutting surfaces 8c of the connecting portion 8-1 and the connecting portion 8-2 being brought into contact with each other when the horizontal materials 3 reach a predetermined opening degree, and the expansion of the mask frame 1 is maintained, as illustrated in FIG. 9(c).

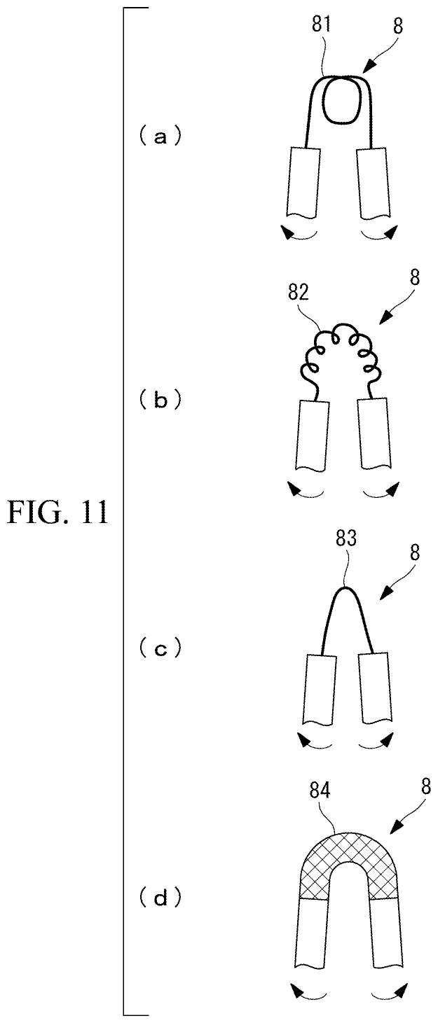

Also, the joint members 8 may be helical coil springs 81 as illustrated in FIG. 11(a), spring coil springs 82 in FIG. 11(b), leaf springs 83 in FIG. 11(c), or members 84 made of a soft resin in FIG. 11(d), for example, using elasticity of the material.

As described above, according to the present embodiment, a space is constantly kept between the mask 30 and the part of and around the mouth and the noise by the mask frame 1. In this manner, the mouth and the nose do not come into contact with the mask 30, the wearer does not feel uncomfortable at the time of talking, and makeup collapse due to adhesion of lip colors and cosmetics to the mask 30 is prevented. Also, the mask 30 does not stick to the mouth and the nose due to breathing. Moreover, since the maximum space allowable in the relationship between the dimension of the mask 30 and the face shape is secured by the support of the warping of the reinforcing materials 4 projecting in the upward direction or the downward direction from each of the horizontal materials 3a and 3c, an air passing area of the filter 32 is kept wide. As a result, difficulties in breathing are not felt at the time of deep breathing during exercising or at the time of sleeping. Although there is a concern that contact of the mask 30 with the face skin for a long period of time may lead to hypersensibility, the mask frame 1 can reduce the area in which the mask 30 comes into contact with the skin and enables wearing for a long period of time without causing the hypersensibility. Effects of these advantages can be exhibited in a situation in which the mask 30 has to be worn for a long period of time, such as a medical worker, a healthcare worker, or a patient who suffers from a severe pollen allergy, in particular. In addition, since the breath is equally released without any resistance from the passing surface of the filter 32 maintained to be wide and the pressure inside the mask 30 is lowered when the wearer exhales, the blown-out breath leaking from the clearance between the upper portion of the mask 30 and the nose is reduced, and fogging-up of glasses is also curbed.

Also, according to the positional relationship between each member of the mask frame 1 and the mask 30, outward expansion of the mask 30 below the eyes is curbed, and thus the mask 30 does not enter the vision. In addition, since the contact location between the mask frame 1 and the face is limited to the cheeks with a small movable width, the chin does not come into contact with the mask frame 1 even if the wearer opens his/her mouth, the wearer can more easily talk as compared with a case in which the mask frame 1 is not used or as compared with the frame in the related art, and positional deviation and shape collapse of the mask 30 do not happen often if the wearer talks. Effects of these advantages are exhibited in a situation in which the wearer speaks with mouth widely moved in front of audience while reading notes held with his/her hands, in particular.

The vertical materials 2, the horizontal materials 3, and the reinforcing materials 4 of the mask frame 1 according to the present embodiment are plate-shaped members or line-shaped members made of a synthetic resin and have shapes that can be changed to some extent when they are warmed. The wearer can use this property to perform adjustment of curbing the outward expansion of the mask 30 below the eyes or expanding the mask frame 1 such that the chin does not come into contact with the mask frame 1 even when the wearer opens his/her mouth in accordance with the face shape or preference of the wearer.

Moreover, the mask frame 1 is secured to the both ends of the mask 30 in the width direction using the tapes 6, the mask 30 is unlikely to be widened in the up-down direction, and the shape of the mask 30 is maintained without causing shape collapse.

Also, a deep three-dimensional depression is formed in the mask 50 as illustrated in FIG. 6. If the wearer adjusts the shape of the mask frame 1 into a smooth shape in advance such that a curvature of the bent shape of the mask frame 1 becomes small, the mask frame 1 is secured to the mask 50 due to an elastic force in a direction in which the mask frame 1 is to spread when the mask frame 1 is placed in contact with the mask 50. Therefore, the mask frame 1 is secured merely by pressing the mask frame 1 against the mask 50, and it is thus possible to use the mask frame 1 without securing the mask 50 with tapes.

### REFERENCE SIGNS LIST

1 Mask frame
2 Vertical material
3, 3a, 3b, 3c Horizontal material
4 Reinforcing material
4a First reinforcing material
4a-1 Upper end portion
4b Second reinforcing material
5, 6 Tape
7 Projecting portion
8 Joint member
8-1, 8-2 Connecting portion
8a Through-hole
8b Projecting portion
8c Abutting surface
30, 50 Mask
32, 52 Filter
32a Through-hole
33, 53 Ear hook portion
34 Wire

1. A mask frame comprising:
two vertical materials that are plate-shaped members or line-shaped members, are disposed such that a longitudinal direction of the vertical materials is aligned along an up-down direction when the mask frame is worn on a face, and come into contact with left and right cheeks, respectively;
a plurality of horizontal materials that are plate-shaped members or line-shaped members provided between the vertical materials such that a longitudinal direction of the horizontal materials is aligned along a horizontal direction, have end portions connected to the vertical materials, and are disposed at positions away from the face when the mask frame is worn on the face; and
a reinforcing material that is a plate-shaped member or a line-shaped member, is disposed such that a longitudinal direction of the reinforcing material is aligned along the up-down direction when the mask frame is worn on the face, and is connected to each of the plurality of horizontal materials,
wherein the vertical materials, the horizontal materials, and the reinforcing material are placeable further inward than an outer peripheral edge of a filter of a mask, and
all the plurality of horizontal materials are away from the face such that no part of each horizontal material comes into contact with the face when the mask frame is worn on the face.

2. The mask frame according to claim 1, wherein the reinforcing material includes
a first reinforcing material that is connected to each of the plurality of horizontal materials at centers of the horizontal materials, and
a plurality of second reinforcing materials that are connected to each of the plurality of horizontal materials between the vertical materials and the first reinforcing material.

3. The mask frame according to claim 2, wherein the first reinforcing material is placed such that an upper end portion of the first reinforcing material projects further upward than an uppermost horizontal material and/or such that a lower end portion of the first reinforcing material projects further downward than a lowermost horizontal material.

4. The mask frame according to claim 2, wherein the second reinforcing materials are placed such that lower end portions of the second reinforcing materials project further downward than the lowermost horizontal material.

5. The mask frame according to claim 1, wherein the uppermost horizontal material among the plurality of horizontal materials is not bent in a front outer direction between a center portion and end portions when the mask frame is worn on the face and is configured such that the mask is placeable outside a view of a wearer.

6. The mask frame according to claim 1, further comprising:
projecting portions that are provided at both end portions in the horizontal direction such that each projecting portion projects in an outer direction and have a structure securable to the filter.

7. The mask frame according to claim 1, wherein each of all the plurality of horizontal materials has a foldable joint member.

8. A method of using the mask frame according to claim 1, the method comprising the steps of:
disposing the mask frame further inward than an outer peripheral edge of a filter of a mask on a face-side surface of the mask when the mask frame is worn on the face; and
integrating the mask frame with the filter through adhesion with tapes on both sides of the mask frame in a width direction, the tapes being placed with a longitudinal direction of the tapes aligned along an up-down direction.
